(19) United States
(12) Patent Application Publication
(10) Pub. No.: US 2021/0208646 A1
(43) Pub. Date: Jul. 8, 2021

(54) TEMPERATURE CONTROLLING METHOD FOR SERVER, BASEBOARD MANAGEMENT CONTROLLER, AND SERVER TEMPERATURE CONTROLLING SYSTEM

(71) Applicants: INVENTEC (PUDONG) TECHNOLOGY CORPORATION, Shanghai City (CN); INVENTEC CORPORATION, Taipei City (TW)

(72) Inventors: Baozai YU, Shanghai City (CN); Yu-Xi CHEN, Shanghai City (CN); Zhong-Ying QU, Shanghai City (CN)

(73) Assignees: INVENTEC (PUDONG) TECHNOLOGY CORPORATION, Shanghai City (CN); INVENTEC CORPORATION, Taipei City (TW)

(21) Appl. No.: 16/796,770

(22) Filed: Feb. 20, 2020

(30) Foreign Application Priority Data
Jan. 3, 2020 (CN) 202010005672.7

(51) Int. Cl. G06F 1/20; G06F 11/30; G06F 13/38

(52) U.S. Cl. CPC G06F 1/206; G06F 13/385; G06F 11/3058

(57) ABSTRACT

The present disclosure provides a temperature controlling method for a server, a baseboard management controller and a server temperature controlling system. The method is applied to the baseboard management controller and the server comprises a management engine and a fan. The method comprises obtaining a server temperature information collected by the management engine and controlling the fan according to the server temperature information when the management engine is in a normal state; and collecting the sever temperature information and controlling the fan according to the server temperature information when the management engine is in an abnormal state. The temperature controlling method for the server, the baseboard management controller, and the server temperature controlling system can collect the server temperature in real time for controlling the server temperature without being affected by the working state of the management engine.

### CROSS-REFERENCE TO RELATED APPLICATIONS

This non-provisional application claims priority under 35 U.S.C. § 119(a) on Patent Application No(s). 202010005672.7 filed in China on Jan. 3, 2020, the entire contents of which are hereby incorporated by reference.

### BACKGROUND

### 1. Technical Field

This disclosure relates to a temperature control, especially for a temperature controlling method for a server, a server temperature controlling system, and a baseboard management controller.

### 2. Related Art

In the prior art, temperatures of a central processing unit (CPU), a memory, and other components in a server are usually read by a management engine (ME), and the management engine controls a rotating speed of a fan based on the temperatures. The management engine is an independent framework relative to the central processing unit, a basic input output system/a uniform extensible firmware interface (BIOS/UEFI). The independent framework comprises a hardware portion and a software portion. The hardware portion corresponds to different CPUs (ARC4/5, SPARC and x86) according to different versions of the management engine. With respect to the software portion, the basic input and output system (BIOS), a network interface card (GBE) and other hardware modules are packaged together.

However, if the management engine is broken, the management engine can't read the temperatures of the central processing unit and the memory. Even if the temperatures are very high, the management engine can't accelerate the rotating speed of the fan, which causes a temperature of a mainboard of the server is too high. The performance of the server will be degraded and some unpredictable consequences may possibly be happened when the temperature of the mainboard of the server is too high.

### SUMMARY

To achieve the above and other related purposes, one or more embodiment of this disclosure provides a temperature controlling method for a server which comprises a management engine and a fan, with the method applied to a baseboard management controller and comprising: obtaining a server temperature information collected by the management engine and controlling the fan according to the server temperature information when the management engine is in a normal state; and collecting the sever temperature information and controlling the fan according to the server temperature information when the management engine is in an abnormal state.

According to one or more embodiment of this disclosure, the baseboard management controller collects the server temperature information via a platform environment control interface.

According to one or more embodiment of this disclosure, the baseboard management controller communicates with the management engine based on a general purpose input/output.

According to one or more embodiment of this disclosure, the management engine is in the normal state when the general purpose input/output is in a first state, and the management engine collects the server temperature information according to the first state of the general purpose input/output; the management engine is in the abnormal state when the general purpose input/output is in a second state, and the baseboard management controller collects the server temperature information according to the second state of the general purpose input/output.

One or more embodiment of this disclosure provides a baseboard management controller, the baseboard management controller is configured to control a temperature of a server which comprises a management engine and a fan and comprises a first control module and a second control module, wherein the first control module obtains a server temperature information collected by the management engine and controls the fan according to the server temperature information when the management engine is in a normal state, the second control module collects the server temperature information and controls the fan according to the server temperature information when the management engine is in an abnormal state.

According to one or more embodiment of this disclosure, the second control module collects the server temperature information via a platform environment control interface.

According to one or more embodiment of this disclosure, the first control module communicates with the management engine based on a general purpose input/output.

According to one or more embodiment of this disclosure, the management engine is in the normal state when the general purpose input/output is in a first state, and the management engine collects the server temperature information according to the first state of the general purpose input/output; the management engine is in the abnormal state when the general purpose input/output is in a second state, and the baseboard management controller collects the server temperature information according to the second state of the general purpose input/output.

Finally, one or more embodiment of this disclosure provides a server temperature controlling system comprising the baseboard management controller, the management engine and the fan claimed in one of claims 5-8, wherein the management engine collects a server temperature information and outputs the server temperature information to the baseboard management controller when the management engine is in a normal state, and the fan regulates a temperature of a server under a control of the baseboard management controller.

According to one or more embodiment of this disclosure, the server temperature information comprises a central processing unit temperature information and a memory temperature information.

As described above, the temperature controlling method for the server, the baseboard management controller, and the server temperature controlling system of the disclosure have the beneficial effects as the following: (1) the server temperature can be collected in real time for controlling the server temperature, which ensures the stability of the performance of the server. (2) the collection of the server temperature is not affected by the working state of the management engine.

### BRIEF DESCRIPTION OF THE DRAWINGS

The present disclosure will become more fully understood from the detailed description given herein below and the accompanying drawings which are given by way of illustration only and thus are not limitative of the present disclosure and wherein:

FIG. 1 is a flowchart of a temperature controlling method for a server according to an embodiment of the present disclosure;

FIG. 2 is a schematic diagram of a baseboard management controller according to an embodiment of the present disclosure; and

FIG. 3 is schematic diagram of a server temperature controlling system according to an embodiment of the present disclosure.

### DETAILED DESCRIPTION

In the following detailed description, for purposes of explanation, numerous specific details are set forth in order to provide a thorough understanding of the disclosed embodiments. It will be apparent, however, that one or more embodiments may be practiced without these specific details. In other instances, well-known structures and devices are schematically shown in order to simplify the drawings.

A temperature controlling method for a server, a baseboard management controller, and a server temperature controlling system of the present disclosure can collect a server temperature in real time for controlling the server temperature through the baseboard management controller or the management engine, which ensures the controllability of the server temperature and avoids various potential risks caused by a temperature imbalance.

The temperature controlling method for the server of the present disclosure is applied to the baseboard management controller (BMC). The baseboard management controller can upgrade a firmware, check a machine equipment and execute other operations in the server when the server is in a turned off state, thereby a local diagnostic, a remote diagnostic, a control platform support, a configuration management, a hardware management, and a trouble shooting can be realized.

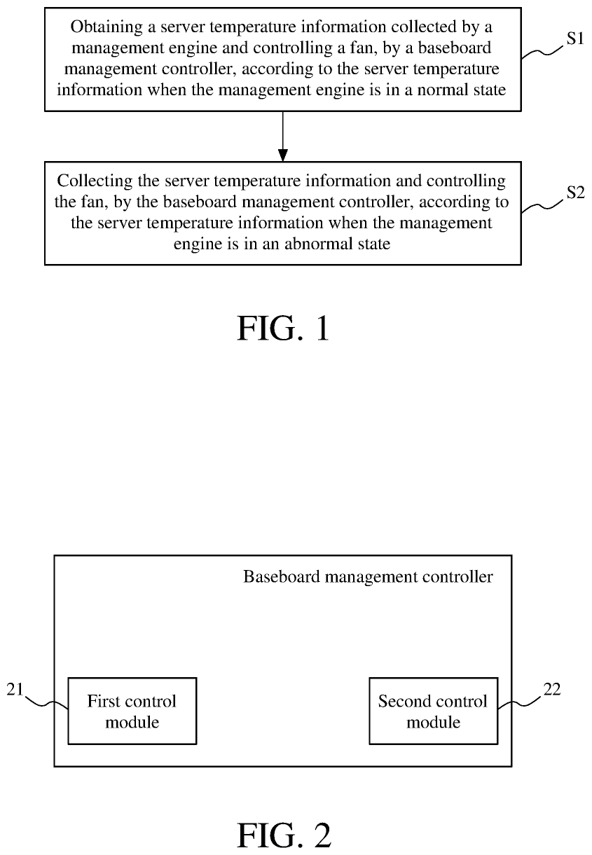

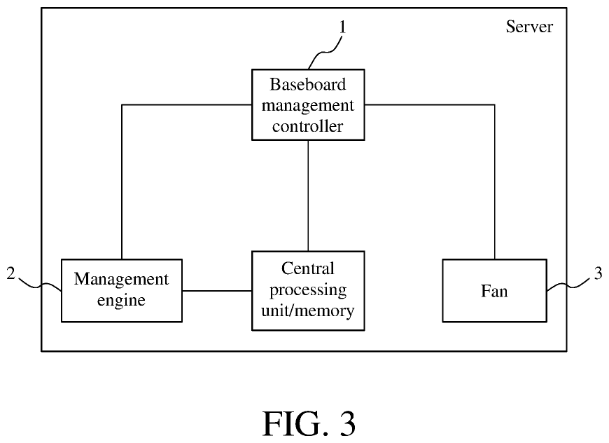

As shown in FIG. 1 and FIG. 3, in an embodiment of the present disclosure, a temperature controlling method for a server comprises steps as the following:

Step S1 is obtaining a server temperature information collected by a management engine 2 and controlling a fan 3, by a baseboard management controller 1, according to the server temperature information when the management engine 2 is in a normal state.

Specifically, when the management engine 2 is in the normal state, the management engine 2 collects the server temperature information through a platform environment control interface (PECI), and transmits the server temperature information to the baseboard management controller 1 through a general purpose input/output (GPIO). Wherein the specification of the PECI was proposed by Intel Corporation to serve as a new-generation digital interface, and the PECI is a special single wire bus that exists between a processor and other chips or other system stability monitoring equipment. The PECI can transmit a processor core temperature read by a digital thermal sensor (DTS) in a main processor of the server. The PECI can report the temperature of the central processing unit (CPU), but is not responsible for transmitting voltage information. A GPIO pin can be freely used by any user, and a pin can serve as a general-purpose input (GPI) or a general-purpose output (GPO) or a general-purpose input/output (GPIO). After the baseboard management controller 1 receives the server temperature information, the baseboard management controller 1 adjusts a rotating speed of the fan 3 in the server according to the server temperature information, which ensures that the server is in an appropriate temperature range. For example, when the temperature of the server is too high, the baseboard management controller 1 accelerates the rotating speed of the fan 3; when the temperature of the server is too low, the baseboard management controller 1 decreases the rotating speed of the fan 3.

Wherein the server temperature information comprises a central processing temperature information and a memory temperature information in the server. Step S2 is collecting the server temperature information and controlling the fan 3, by the baseboard management controller 1, according to the server temperature information when the management engine 2 is in an abnormal state.

Specifically, when the management engine 2 is in the abnormal state, the management engine 2 can't collect the server temperature information, so the baseboard management controller 1 directly collects the server temperature information through the PECI and adjusts the rotating speed of the fan 3 according to the server temperature information, which ensures that the server is in a suitable temperature range, thereby ensuring an effective control of the server temperature.

In an embodiment of the present disclosure, the working state of the management engine 2 is controlled by a GPIO signal between the management engine 2 and the baseboard management controller 1. Specifically, when the management engine 2 is in the normal state, the GPIO signal is in a first state (such as a high level), the management engine 2 collects the server temperature information according to the first state of the GPIO signal and the baseboard management controller 1 waits the server temperature information read by the management engine 2. When the management engine 2 is in the abnormal state, the GPIO signal is in a second state (such as a low level), the baseboard management controller 1 collects the server temperature information according to the second state of the GPIO signal. Preferably, an analog switch is provided on the PECI of a server mainboard, and the analog switch is controlled by the GPIO signal. The analog switch is connected to the management engine 2 or the baseboard management controller 1 according to the value of the GPIO signal.

As shown in FIG. 2, in an embodiment of the present disclosure, the baseboard management controller 1 is used to control the temperature of the server, and the server comprises the management engine 2 and the fan 3.

The baseboard management controller 1 comprises a first control module 21 and a second control module 22.

The first control module 21 is configured to obtain the server temperature information collected by the management engine 1 and control the fan 3 according to the server temperature information when the management engine 1 is in the normal state.

Specifically, when the management engine 2 is in the normal state, the management engine 2 collects the server temperature information through the platform environment control interface (PECI), and transmits the server temperature information to a baseboard management controller 1 through the general purpose input/output port (GPIO). Wherein the specification of the PECI was proposed by Intel Corporation to serve as a new-generation digital interface, and the PECI is a special single wire bus that exists between a processor and other chips or other system stability monitoring equipment. The PECI can transmit the processor core temperature read by the digital thermal sensor (DTS) in the main processor of the server. The PECI can report the temperature of the central processing unit (CPU), but is not responsible for transmitting voltage information. A GPIO pin can be freely used by any user, and a pin can serve as a general-purpose input (GPI) or a general-purpose output (GPO) or a general-purpose input/output (GPIO). After the baseboard management controller 1 receives the server temperature information, the baseboard management controller 1 adjusts the rotating speed of the fan 3 in the server according to the server temperature information, which ensures that the server is in an appropriate temperature range. For example, when the temperature of the server is too high, the baseboard management controller 1 accelerates the rotating speed of the fan 3; when the temperature of the server is too low, the baseboard management controller 1 decreases the rotating speed of the fan 3.

Wherein the server temperature information comprises the central processing unit temperature information and the memory temperature information in the server.

The second control module 22 is configured to collect the server temperature information and control the fan 3 according to the server temperature information when the management engine 2 is in the abnormal state.

Specifically, when the management engine 2 is in the abnormal state, the management engine 2 can't collect the server temperature information, so the baseboard management controller 1 directly collects the server temperature information through the PECI and adjusts the rotating speed of the fan 3 according to the server temperature information, which ensures that the server is in a suitable temperature range, thereby ensuring an effective control of the server temperature.

In an embodiment of the present disclosure, the working state of the management engine 2 is controlled by a GPIO signal between the management engine 2 and the baseboard management controller 1. Specifically, when the management engine 2 is in the normal state, the GPIO signal is in a first state (such as a high level), the management engine 2 collects the server temperature information according to the first state of the GPIO signal and the baseboard management controller 1 waits the server temperature information read by the management engine 2. When the management engine 2 is in the abnormal state, the GPIO signal is in a second state (such as a low level), the baseboard management controller 1 collects the server temperature information according to the second state of the GPIO signal. Preferably, an analog switch is provided on the PECI of a server mainboard, and the analog switch is controlled by the GPIO signal. The analog switch is connected to the management engine 2 or the baseboard management controller 1 according to the value of the GPIO signal.

It should be noted that each of the modules in the above device is only a division of logical functions. In actual implementation, these modules may be fully or partially integrated into a physical entity, or may be physically separated. And these modules all can be implemented in a form of processing element call software, or can be implemented in a form of hardware, or a part of the modules can be implemented in the form of processing element call software and the other part of the modules can be implemented in the form of hardware. For example, the x module may be an independent processing element or may be integrated in a chip of the above device. In addition, the x module may also be stored in a memory of the above device in a form of program code, and the function of the x module may be called and executed by a processing element of the above device. The implementation of the other module is similar as that of the x module. In addition, all of these modules or a part of these modules can be integrated together, or they can be implemented independently. The processing element described herein may be an integrated circuit with signal processing capabilities. In an implementation process, each step of the above method or each of the above modules may be completed by an integrated logic circuit of a hardware in a processor element or an instruction in the form of software.

For example, the above modules may be one or more integrated circuits configured to implement the above methods, such as one or more application specific integrated circuits (ASICs), or one or more digital signal processor (DSP), or one or more field programmable gate array (FPGA). As another example, when one of the above modules is implemented in the form of a processing element scheduler code, the processing element may be a general-purpose processor, such as a central processing unit (CPU) or other processors that can tune program codes. As another example, these modules can be integrated together and implemented in the form of a system-on-a-chip (SOC).

As shown in FIG. 3, in an embodiment of the disclosure, the server temperature controlling system comprises the baseboard management controller 1, the management engine 2 and the fan 3.

The management engine 2 is configured to collect the server temperature information and transmits the server temperature information to the baseboard management controller 1 when the management engine 2 is in the normal state. The fan 3 is configured to adjust the server temperature under the control of the baseboard management controller 1. Specifically, the management engine 2 and the baseboard management controller 1 collect the server temperature information through the PECI, and the management engine 2 and the baseboard management controller 1 communicate with each other through the GPIO signal. In an embodiment of the present disclosure, the server temperature information comprises the central processing unit temperature information and the memory temperature information.

In summary, the temperature controlling method for the server, the baseboard management controller, and the server temperature controlling system of the present disclosure can collect the server temperature in real time for controlling the server temperature, which ensures the stability of performance of server is not affected by the working state of the management engine. Therefore, the present disclosure effectively overcomes various shortcomings in the prior art and has a high industrial availability.

1. A temperature controlling method for a server which comprises a management engine and a fan, with the method applied to a baseboard management controller and comprising:
collecting a server temperature information by the management engine when the management engine is in a normal state;
controlling the fan by the baseboard management controller according to the server temperature information when the management engine is in the normal state;
collecting the sever temperature information by the baseboard management controller when the management engine is in an abnormal state; and
controlling the fan by the baseboard management controller according to the server temperature information when the management engine is in the abnormal state.

2. The method in claim 1, wherein the baseboard management controller collects the server temperature information via a platform environment control interface.

3. The method in claim 1, wherein the baseboard management controller communicates with the management engine based on a general purpose input/output.

4. The method in claim 3, wherein the management engine is in the normal state when the general purpose input/output is in a first state, and the management engine collects the server temperature information according to the first state of the general purpose input/output; the management engine is in the abnormal state when the general purpose input/output is in a second state, and the baseboard management controller collects the server temperature information according to the second state of the general purpose input/output.

5. A baseboard management controller configured to control a temperature of a server which comprises a management engine and a fan, with the baseboard management controller comprising:
a first control module and a second control module;
wherein the first control module obtains a server temperature information collected by the management engine and controls the fan according to the server temperature information when the management engine is in a normal state; the second control module collects the server temperature information and controls the fan according to the server temperature information when the management engine is in an abnormal state.

6. The baseboard management controller in claim 5, wherein the second control module collects the server temperature information via a platform environment control interface.

7. The baseboard management controller in claim 5, wherein the first control module communicates with the management engine based on a general purpose input/output.

8. The baseboard management controller in claim 7, wherein the management engine is in the normal state when the general purpose input/output is in a first state, and the management engine collects the server temperature information according to the first state of the general purpose input/output; the management engine is in the abnormal state when the general purpose input/output is in a second state, and the baseboard management controller collects the server temperature information according to the second state of the general purpose input/output.

9. A server temperature controlling system, comprising the baseboard management controller, the management engine and the fan claimed in claim 5;
wherein the management engine collects a server temperature information and transmits the server temperature information to the baseboard management controller when the management engine is in a normal state, and the fan regulates a temperature of a server under a control of the baseboard management controller.

10. The sever temperature controlling system in claim 9, wherein the server temperature information comprises a central processing unit temperature information and a memory temperature information.

11. A server temperature controlling system, comprising the baseboard management controller, the management engine and the fan claimed in claim 6;
wherein the management engine collects a server temperature information and transmits the server temperature information to the baseboard management controller when the management engine is in a normal state, and the fan regulates a temperature of a server under a control of the baseboard management controller.

12. The sever temperature controlling system in claim 11, wherein the server temperature information comprises a central processing unit temperature information and a memory temperature information.

13. A server temperature controlling system, comprising the baseboard management controller, the management engine and the fan claimed in claim 7;
wherein the management engine collects a server temperature information and transmits the server temperature information to the baseboard management controller when the management engine is in a normal state, and the fan regulates a temperature of a server under a control of the baseboard management controller.

14. The sever temperature controlling system in claim 13, wherein the server temperature information comprises a central processing unit temperature information and a memory temperature information.

15. A server temperature controlling system, comprising the baseboard management controller, the management engine and the fan claimed in claim 8;
wherein the management engine collects a server temperature information and transmits the server temperature information to the baseboard management controller when the management engine is in a normal state, and the fan regulates a temperature of a server under a control of the baseboard management controller.

16. The sever temperature controlling system in claim 15, wherein the server temperature information comprises a central processing unit temperature information and a memory temperature information.
